(19) United States
(12) Patent Application Publication
(10) Pub. No.: US 2014/0189192 A1
(43) Pub. Date: Jul. 3, 2014

(54) APPARATUS AND METHOD FOR A MULTIPLE PAGE SIZE TRANSLATION LOOKASIDE BUFFER (TLB)

(71) Applicants: Shlomo Raikin, Ofer (IL); Oren Hamama, Bangalore (IN); Robert S. Chappell, Portland, OR (US); Camron B. Rust, Hillsboro, OR (US); Han S. Luu, Portland, OR (US); Leslie A. Ong, Portland, OR (US); Gur Hildesheim, Haifa (IL)

(72) Inventors: Shlomo Raikin, Ofer (IL); Oren Hamama, Bangalore (IN); Robert S. Chappell, Portland, OR (US); Camron B. Rust, Hillsboro, OR (US); Han S. Luu, Portland, OR (US); Leslie A. Ong, Portland, OR (US); Gur Hildesheim, Haifa (IL)

(21) Appl. No.: 13/730,411

(22) Filed: Dec. 28, 2012

(51) Int. Cl. G06F 12/10

(52) U.S. Cl. CPC G06F 12/1045
USPC 711/3

(57) ABSTRACT

An apparatus and method for implementing a multiple page size translation lookaside buffer (TLB). For example, a method according to one embodiment comprises: reading a first group of bits and a second group of bits from a linear address; determining whether the linear address is associated with a large page size or a small page size; identifying a first cache set using the first group of bits if the linear address is associated with a first page size and identifying a second cache set using the second group of bits if the linear address is associated with a second page size; and identifying a first cache way if the linear address is associated with a first page size and identifying a second cache way if the linear address is associated with a second page size.

### BACKGROUND

1. Field of the Invention

This invention relates generally to the field of computer processors. More particularly, the invention relates to an apparatus and method for a multiple page size TLB.

2. Description of the Related Art

Memory addressing schemes often use a technique called paging to implement virtual memory. When using paging, the virtual address space (i.e., the address space generated by either the execution unit of a processor or by the execution unit in conjunction with a segmentation unit of a processor) is divided into fix sized blocks called pages, each of which can be mapped onto any of the physical addresses (i.e., the addresses that correspond to hardware memory locations) available on the system. In a typical computer system, a memory management unit determines and maintains, according to paging algorithm(s), the current mappings for the virtual to physical addresses using one or more page tables.

Upon receiving a virtual address from the execution unit of a processor, also sometimes referred to as a linear address (LA), typical memory management units initially translate the LA into its corresponding physical address using the page table(s). Since the page table(s) are often stored in main memory, accessing the page tables is time consuming. To speed up the paging translations, certain computer systems store the most recently used translations in a translation look-aside buffer or TLB (a faster memory that is often located on the processor). Upon generating a LA requiring translation, the memory management unit first searches for the translation in the TLB before accessing the page table(s). If the translation is stored in the TLB, a TLB “hit” is said to have occurred and the TLB provides the translation. However, if the translation is not stored in the TLB, a TLB “miss” is said to have occurred and a page table walker is invoked to access the page tables and provide the translation.

Traditional TLB caches have a separate array for each page size (PS). For Intel Architecture (IA), the supported page sizes are 4 KB, 2 MB/4 MB and 1 GB each of which has one or more dedicated TLB arrays. Because each page size has a different number of translated and un-translated LA bits, the formation of the set bits and the tag bits differs from one page size to another. For example, as illustrated in FIG. 8, the set bits 801 of a 16-set 4K TLB array would be LA[15:12], the tag bits 802 would be LA[::16], and the offset bits 800 would be LA[11:0]. In contrast, for a 16-set 2M TLB array, the set bits 811 would be LA[24:21], the tag bits 812 would be LA[::25], and the offset bits 810 would be LA[20:0] (a larger offset 810 would logically be required to address the larger page size).

The description above shows why it is natural to implement a separate array per page size and why it is non-trivial to unify the TLB arrays. Another problem with a unified array is how to identify which page size is cached in each entry.

The main problem with the separate array configuration is a waste of area and power compared to the average TLB utilization. For example, in many workloads, the applications being executed use many 4K pages and few or none of the 2M pages. In this scenario, the 4K array may be full and insufficient in size, while the 2M array is almost or completely empty.

### BRIEF DESCRIPTION OF THE DRAWINGS

A better understanding of the present invention can be obtained from the following detailed description in conjunction with the following drawings, in which:

FIG. 1A is a block diagram illustrating both an exemplary in-order pipeline and an exemplary register renaming, out-of-order issue/execution pipeline according to embodiments of the invention;

FIG. 1B is a block diagram illustrating both an exemplary embodiment of an in-order architecture core and an exemplary register renaming, out-of-order issue/execution architecture core to be included in a processor according to embodiments of the invention;

FIG. 2 is a block diagram of a single core processor and a multicore processor with integrated memory controller and graphics according to embodiments of the invention;

FIG. 3 illustrates a block diagram of a system in accordance with one embodiment of the present invention;

FIG. 4 illustrates a block diagram of a second system in accordance with an embodiment of the present invention;

FIG. 5 illustrates a block diagram of a third system in accordance with an embodiment of the present invention;

FIG. 6 illustrates a block diagram of a system on a chip (SoC) in accordance with an embodiment of the present invention;

FIG. 7 illustrates a block diagram contrasting the use of a software instruction converter to convert binary instructions in a source instruction set to binary instructions in a target instruction set according to embodiments of the invention;

FIG. 8 illustrates different sizes for linear addresses used in one embodiment of the invention;

FIG. 9 illustrates a system architecture according to one embodiment of the invention;

FIGS. 10A-B illustrate a tag array, data array and associated logic employed in one embodiment of the invention; and

FIG. 11 illustrates a method in accordance with one embodiment of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

### Exemplary Processor Architectures and Data Types

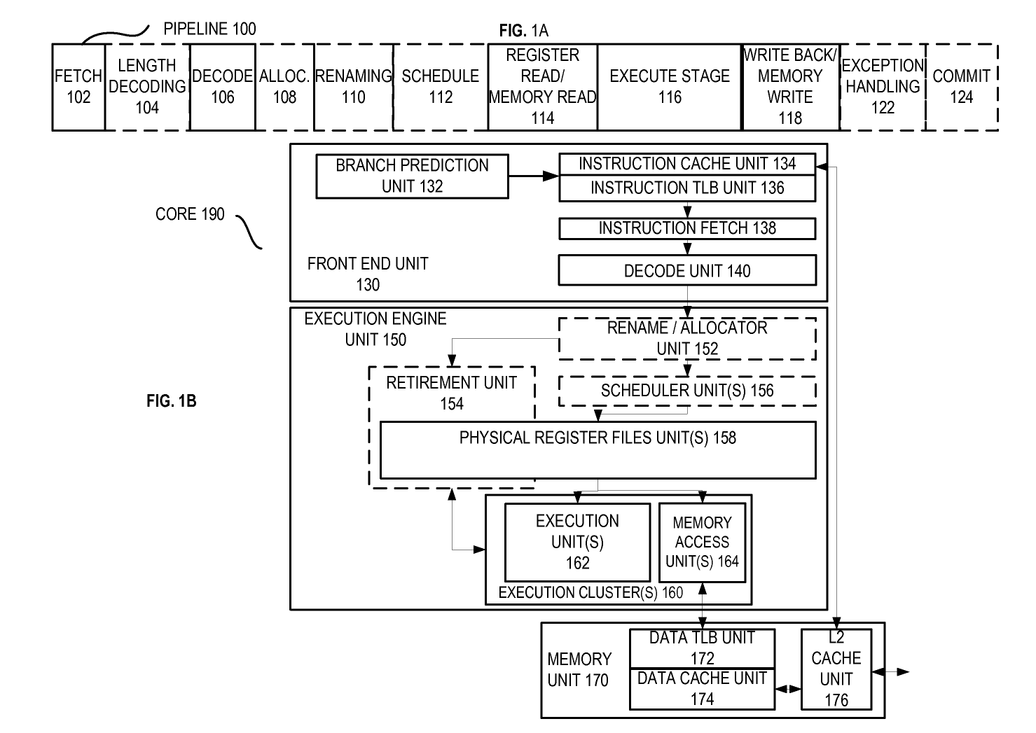

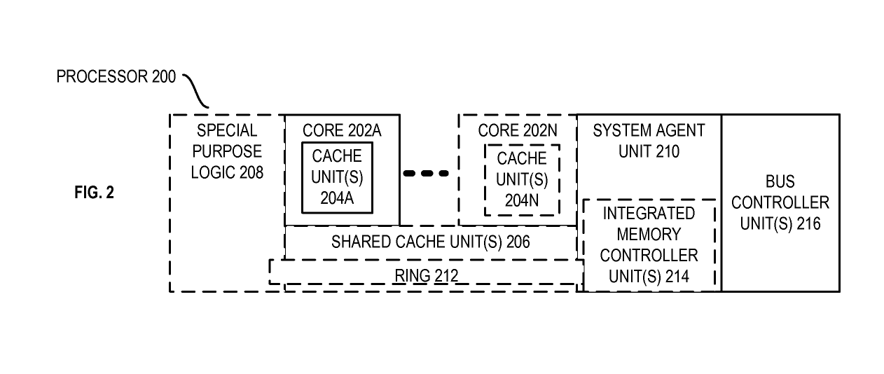

FIG. 1A is a block diagram illustrating both an exemplary in-order pipeline and an exemplary register renaming, out-of-order issue/execution pipeline according to embodiments of the invention. FIG. 1B is a block diagram illustrating both an exemplary embodiment of an in-order architecture core and an exemplary register renaming, out-of-order issue/execution architecture core to be included in a processor according to embodiments of the invention. The solid lined boxes in FIGS. 1A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 1A, a processor pipeline 100 includes a fetch stage 102, a length decode stage 104, a decode stage 106, an allocation stage 108, a renaming stage 110, a scheduling (also known as a dispatch or issue) stage 112, a register read/memory read stage 114, an execute stage 116, a write back/memory write stage 118, an exception handling stage 122, and a commit stage 124.

FIG. 1B shows processor core 190 including a front end unit 130 coupled to an execution engine unit 150, and both are coupled to a memory unit 170. The core 190 may be a reduced instruction set computing (RISC) core, a complex instruction set computing (CISC) core, a very long instruction word (VLIW) core, or a hybrid or alternative core type. As yet another option, the core 190 may be a special-purpose core, such as, for example, a network or communication core, compression engine, coprocessor core, general purpose computing graphics processing unit (GPGPU) core, graphics core, or the like.

The front end unit 130 includes a branch prediction unit 132 coupled to an instruction cache unit 134, which is coupled to an instruction translation lookaside buffer (TLB) 136, which is coupled to an instruction fetch unit 138, which is coupled to a decode unit 140. The decode unit 140 (or decoder) may decode instructions, and generate as an output one or more micro-operations, microcode entry points, microinstructions, other instructions, or other control signals, which are decoded from, or which otherwise reflect, or are derived from, the original instructions. The decode unit 140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 190 includes a microcode ROM or other medium that stores microcode for certain macroinstructions (e.g., in decode unit 140 or otherwise within the front end unit 130). The decode unit 140 is coupled to a rename/allocator unit 152 in the execution engine unit 150.

The execution engine unit 150 includes the rename/allocator unit 152 coupled to a retirement unit 154 and a set of one or more scheduler unit(s) 156. The scheduler unit(s) 156 represents any number of different schedulers, including reservations stations, central instruction window, etc. The scheduler unit(s) 156 is coupled to the physical register file(s) unit(s) 158. Each of the physical register file(s) units 158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 158 comprises a vector registers unit, a write mask registers unit, and a scalar registers unit. These register units may provide architectural vector registers, vector mask registers, and general purpose registers. The physical register file(s) unit(s) 158 is overlapped by the retirement unit 154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 154 and the physical register file(s) unit(s) 158 are coupled to the execution cluster(s) 160. The execution cluster(s) 160 includes a set of one or more execution units 162 and a set of one or more memory access units 164. The execution units 162 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 156, physical register file(s) unit(s) 158, and execution cluster(s) 160 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 164). It should also be understood that where separate pipelines are used, one or more of these pipelines may be out-of-order issue/execution and the rest in-order.

The set of memory access units 164 is coupled to the memory unit 170, which includes a data TLB unit 172 coupled to a data cache unit 174 coupled to a level 2 (L2) cache unit 176. In one exemplary embodiment, the memory access units 164 may include a load unit, a store address unit, and a store data unit, each of which is coupled to the data TLB unit 172 in the memory unit 170. The instruction cache unit 134 is further coupled to a level 2 (L2) cache unit 176 in the memory unit 170. The L2 cache unit 176 is coupled to one or more other levels of cache and eventually to a main memory.

By way of example, the exemplary register renaming, out-of-order issue/execution core architecture may implement the pipeline 100 as follows: 1) the instruction fetch 138 performs the fetch and length decoding stages 102 and 104; 2) the decode unit 140 performs the decode stage 106; 3) the rename/allocator unit 152 performs the allocation stage 108 and renaming stage 110; 4) the scheduler unit(s) 156 performs the schedule stage 112; 5) the physical register file(s) unit(s) 158 and the memory unit 170 perform the register read/memory read stage 114; the execution cluster 160 perform the execute stage 116; 6) the memory unit 170 and the physical register file(s) unit(s) 158 perform the write back/memory write stage 118; 7) various units may be involved in the exception handling stage 122; and 8) the retirement unit 154 and the physical register file(s) unit(s) 158 perform the commit stage 124.

The core 190 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 190 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 134/174 and a shared L2 cache unit 176, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

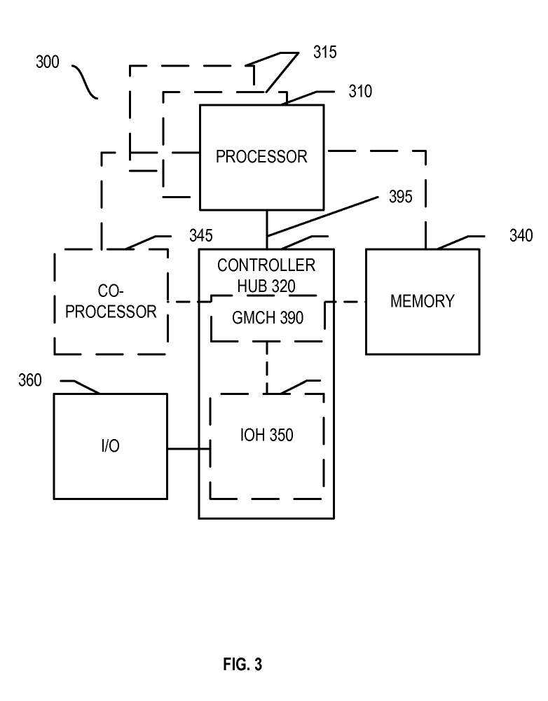

FIG. 2 is a block diagram of a processor 200 that may have more than one core, may have an integrated memory controller, and may have integrated graphics according to embodiments of the invention. The solid lined boxes in FIG. 2 illustrate a processor 200 with a single core 202A, a system agent 210, a set of one or more bus controller units 216, while the optional addition of the dashed lined boxes illustrates an alternative processor 200 with multiple cores 202A-N, a set of one or more integrated memory controller unit(s) 214 in the system agent unit 210, and special purpose logic 208.

Thus, different implementations of the processor 200 may include: 1) a CPU with the special purpose logic 208 being integrated graphics and/or scientific (throughput) logic (which may include one or more cores), and the cores 202A-N being one or more general purpose cores (e.g., general purpose in-order cores, general purpose out-of-order cores, a combination of the two); 2) a coprocessor with the cores 202A-N being a large number of special purpose cores intended primarily for graphics and/or scientific (throughput); and 3) a coprocessor with the cores 202A-N being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 206, and external memory (not shown) coupled to the set of integrated memory controller units 214. The set of shared cache units 206 may include one or more mid-level caches, such as level 2 (L2), level 3 (L3), level 4 (L4), or other levels of cache, a last level cache (LLC), and/or combinations thereof. While in one embodiment a ring based interconnect unit 212 interconnects the integrated graphics logic 208, the set of shared cache units 206, and the system agent unit 210/integrated memory controller unit(s) 214, alternative embodiments may use any number of well-known techniques for interconnecting such units. In one embodiment, coherency is maintained between one or more cache units 206 and cores 202-A-N.

In some embodiments, one or more of the cores 202A-N are capable of multi-threading. The system agent 210 includes those components coordinating and operating cores 202A-N. The system agent unit 210 may include for example a power control unit (PCU) and a display unit. The PCU may be or include logic and components needed for regulating the power state of the cores 202A-N and the integrated graphics logic 208. The display unit is for driving one or more externally connected displays.

The cores 202A-N may be homogenous or heterogeneous in terms of architecture instruction set; that is, two or more of the cores 202A-N may be capable of execution the same instruction set, while others may be capable of executing only a subset of that instruction set or a different instruction set. In one embodiment, the cores 202A-N are heterogeneous and include both the “small” cores and “big” cores described below.

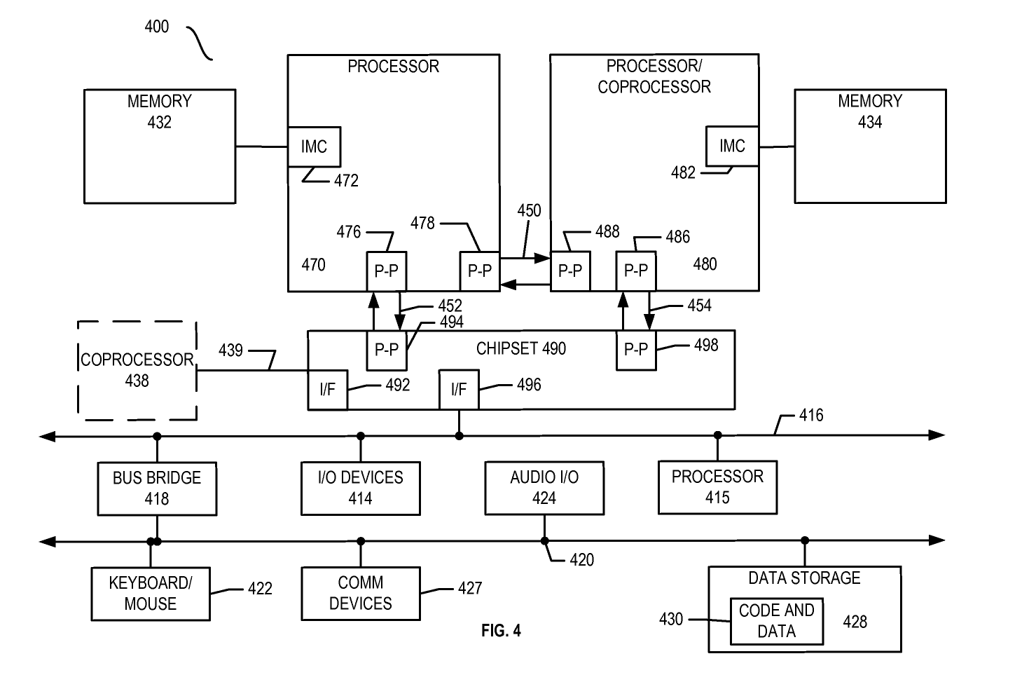

FIGS. 3-6 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 3, shown is a block diagram of a system 300 in accordance with one embodiment of the present invention. The system 300 may include one or more processors 310, 315, which are coupled to a controller hub 320. In one embodiment the controller hub 320 includes a graphics memory controller hub (GMCH) 390 and an Input/Output Hub (IOH) 350 (which may be on separate chips); the GMCH 390 includes memory and graphics controllers to which are coupled memory 340 and a coprocessor 345; the IOH 350 is couples input/output (I/O) devices 360 to the GMCH 390. Alternatively, one or both of the memory and graphics controllers are integrated within the processor (as described herein), the memory 340 and the coprocessor 345 are coupled directly to the processor 310, and the controller hub 320 in a single chip with the IOH 350.

The optional nature of additional processors 315 is denoted in FIG. 3 with broken lines. Each processor 310, 315 may include one or more of the processing cores described herein and may be some version of the processor 200.

The memory 340 may be, for example, dynamic random access memory (DRAM), phase change memory (PCM), or a combination of the two. For at least one embodiment, the controller hub 320 communicates with the processor(s) 310, 315 via a multi-drop bus, such as a frontside bus (FSB), point-to-point interface such as QuickPath Interconnect (QPI), or similar connection 395.

In one embodiment, the coprocessor 345 is a special-purpose processor, such as, for example, a high-throughput MIC processor, a network or communication processor, compression engine, graphics processor, GPGPU, embedded processor, or the like. In one embodiment, controller hub 320 may include an integrated graphics accelerator.

There can be a variety of differences between the physical resources 310, 315 in terms of a spectrum of metrics of merit including architectural, microarchitectural, thermal, power consumption characteristics, and the like.

In one embodiment, the processor 310 executes instructions that control data processing operations of a general type. Embedded within the instructions may be coprocessor instructions. The processor 310 recognizes these coprocessor instructions as being of a type that should be executed by the attached coprocessor 345. Accordingly, the processor 310 issues these coprocessor instructions (or control signals representing coprocessor instructions) on a coprocessor bus or other interconnect, to coprocessor 345. Coprocessor(s) 345 accept and execute the received coprocessor instructions.

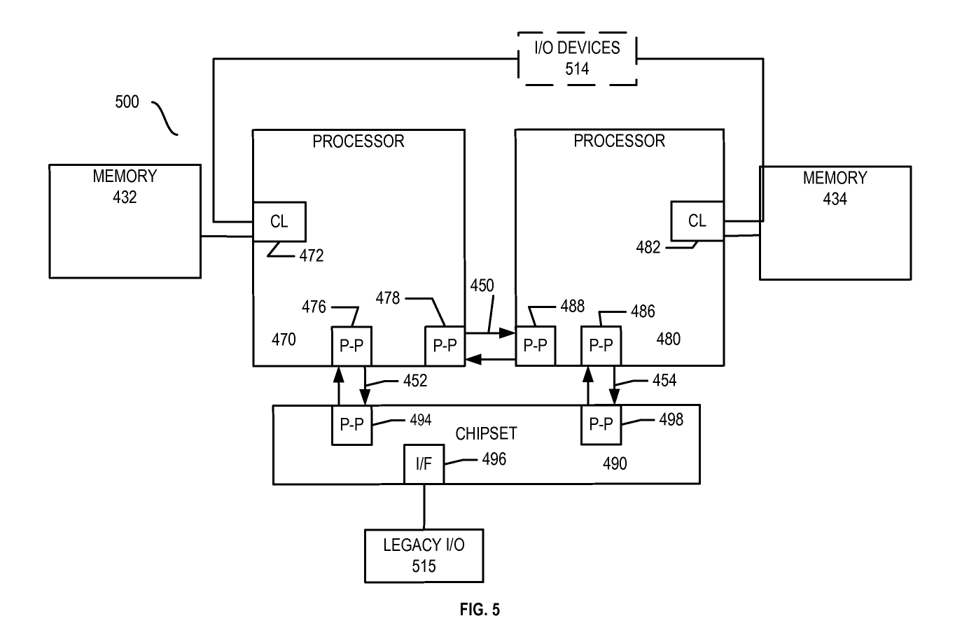

Referring now to FIG. 4, shown is a block diagram of a first more specific exemplary system 400 in accordance with an embodiment of the present invention. As shown in FIG. 4, multiprocessor system 400 is a point-to-point interconnect system, and includes a first processor 470 and a second processor 480 coupled via a point-to-point interconnect 450. Each of processors 470 and 480 may be some version of the processor 200. In one embodiment of the invention, processors 470 and 480 are respectively processors 310 and 315, while coprocessor 438 is coprocessor 345. In another embodiment, processors 470 and 480 are respectively processor 310 coprocessor 345.

Processors 470 and 480 are shown including integrated memory controller (IMC) units 472 and 482, respectively. Processor 470 also includes as part of its bus controller units point-to-point (P-P) interfaces 476 and 478; similarly, second processor 480 includes P-P interfaces 486 and 488. Processors 470, 480 may exchange information via a point-to-point (P-P) interface 450 using P-P interface circuits 478, 488. As shown in FIG. 4, IMCs 472 and 482 couple the processors to respective memories, namely a memory 432 and a memory 434, which may be portions of main memory locally attached to the respective processors.

Processors 470, 480 may each exchange information with a chipset 490 via individual P-P interfaces 452, 454 using point to point interface circuits 476, 494, 486, 498. Chipset 490 may optionally exchange information with the coprocessor 438 via a high-performance interface 439. In one embodiment, the coprocessor 438 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 490 may be coupled to a first bus 416 via an interface 496. In one embodiment, first bus 416 may be a Peripheral Component Interconnect (PCI) bus, or a bus such as a PCI Express bus or another third generation I/O interconnect bus, although the scope of the present invention is not so limited.

As shown in FIG. 4, various I/O devices 414 may be coupled to first bus 416, along with a bus bridge 418 which couples first bus 416 to a second bus 420. In one embodiment, one or more additional processor(s) 415, such as coprocessors, high-throughput MIC processors, GPGPU's, accelerators (such as, e.g., graphics accelerators or digital signal processing (DSP) units), field programmable gate arrays, or any other processor, are coupled to first bus 416. In one embodiment, second bus 420 may be a low pin count (LPC) bus. Various devices may be coupled to a second bus 420 including, for example, a keyboard and/or mouse 422, communication devices 427 and a storage unit 428 such as a disk drive or other mass storage device which may include instructions/code and data 430, in one embodiment. Further, an audio I/O 424 may be coupled to the second bus 420. Note that other architectures are possible. For example, instead of the point-to-point architecture of FIG. 4, a system may implement a multi-drop bus or other such architecture.

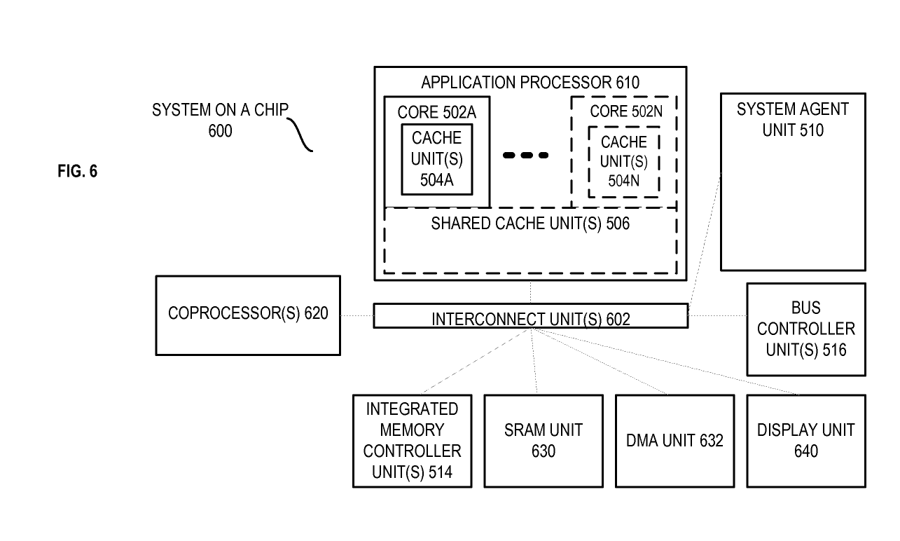

Referring now to FIG. 5, shown is a block diagram of a second more specific exemplary system 500 in accordance with an embodiment of the present invention. Like elements in FIGS. 4 and 5 bear like reference numerals, and certain aspects of FIG. 4 have been omitted from FIG. 5 in order to avoid obscuring other aspects of FIG. 5.

FIG. 5 illustrates that the processors 470, 480 may include integrated memory and I/O control logic (“CL”) 472 and 482, respectively. Thus, the CL 472, 482 include integrated memory controller units and include I/O control logic. FIG. 5 illustrates that not only are the memories 432, 434 coupled to the CL 472, 482, but also that I/O devices 514 are also coupled to the control logic 472, 482. Legacy I/O devices 515 are coupled to the chipset 490.

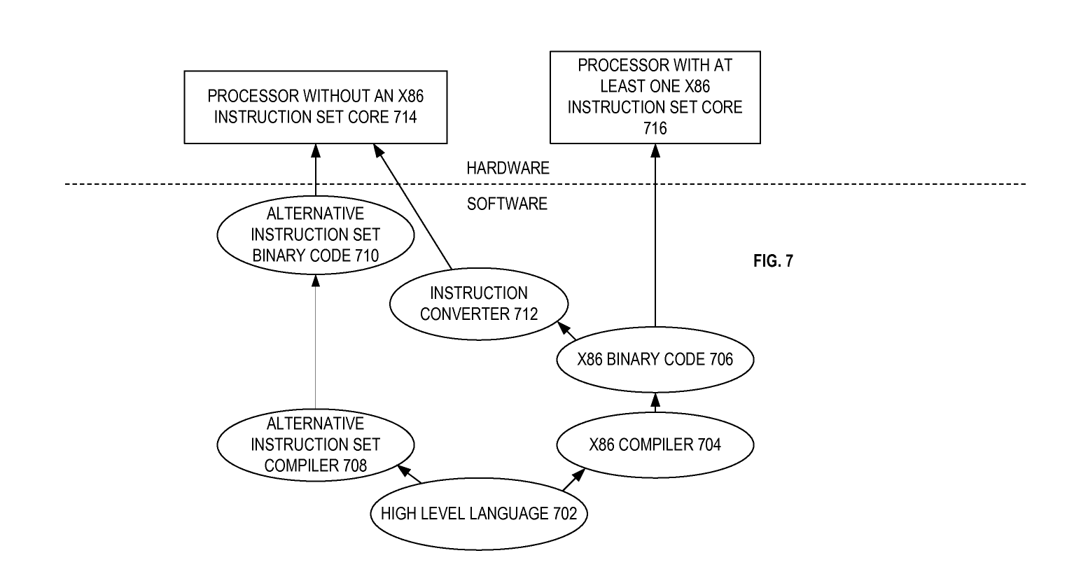

Referring now to FIG. 6, shown is a block diagram of a SoC 600 in accordance with an embodiment of the present invention. Similar elements in FIG. 2 bear like reference numerals. Also, dashed lined boxes are optional features on more advanced SoCs. In FIG. 6, an interconnect unit(s) 602 is coupled to: an application processor 610 which includes a set of one or more cores 202A-N and shared cache unit(s) 206; a system agent unit 210; a bus controller unit(s) 216; an integrated memory controller unit(s) 214; a set or one or more coprocessors 620 which may include integrated graphics logic, an image processor, an audio processor, and a video processor; an static random access memory (SRAM) unit 630; a direct memory access (DMA) unit 632; and a display unit 640 for coupling to one or more external displays. In one embodiment, the coprocessor(s) 620 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 430 illustrated in FIG. 4, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

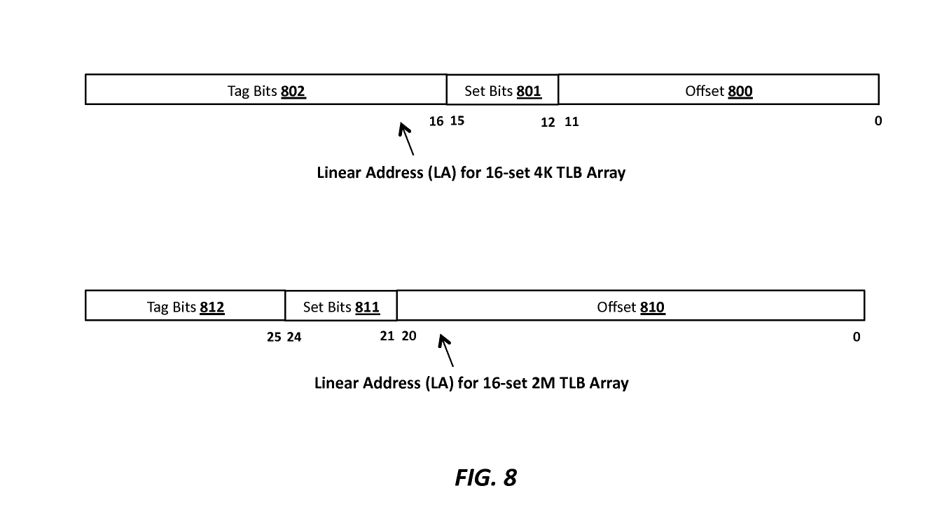

FIG. 7 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 7 shows a program in a high level language 702 may be compiled using an x86 compiler 704 to generate x86 binary code 706 that may be natively executed by a processor with at least one x86 instruction set core 716. The processor with at least one x86 instruction set core 716 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 704 represents a compiler that is operable to generate x86 binary code 706 (e.g., object code) that can, with or without additional linkage processing, be executed on the processor with at least one x86 instruction set core 716. Similarly, FIG. 7 shows the program in the high level language 702 may be compiled using an alternative instruction set compiler 708 to generate alternative instruction set binary code 710 that may be natively executed by a processor without at least one x86 instruction set core 714 (e.g., a processor with cores that execute the MIPS instruction set of MIPS Technologies of Sunnyvale, Calif. and/or that execute the ARM instruction set of ARM Holdings of Sunnyvale, Calif.). The instruction converter 712 is used to convert the x86 binary code 706 into code that may be natively executed by the processor without an x86 instruction set core 714. This converted code is not likely to be the same as the alternative instruction set binary code 710 because an instruction converter capable of this is difficult to make; however, the converted code will accomplish the general operation and be made up of instructions from the alternative instruction set. Thus, the instruction converter 712 represents software, firmware, hardware, or a combination thereof that, through emulation, simulation or any other process, allows a processor or other electronic device that does not have an x86 instruction set processor or core to execute the x86 binary code 706.

### Apparatus and Method for a Multiple-Page Size TLB

The embodiments of the invention set forth below provide an efficient apparatus and method for sharing the same TLB array with more than one page size, so that any TLB entry may contain any page size. While the description below focuses on the use of two particular page sizes for one dispatch port pipeline, 4K (small page size) and 2M (large page size), the underlying principles of the invention may be implemented using any number of page sizes. For example, the underlying principles of the invention may be used with any combination of different page sizes. These embodiments may also be implemented using more than one dispatch port pipeline.

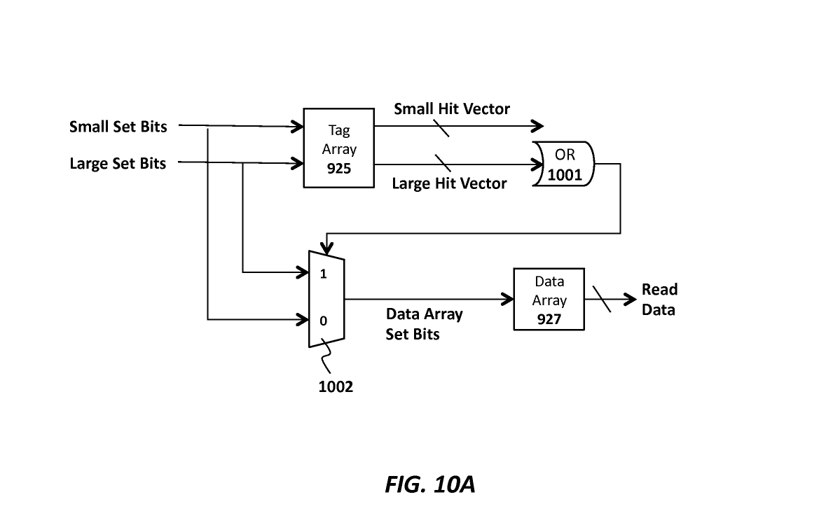

FIG. 9 illustrates an exemplary processor or core 910 which includes an execution unit 904 for executing instructions, a memory management unit (MMU) 920 for providing access to a main memory 910 (e.g., a random access memory), and a register file 901 for storing data and addresses for use by the execution unit 904 and MMU 920. The basic functions performed by these processor components are well understood by those of skill in the art and will not be described here in detail to avoid obscuring the underlying principles of the invention.

The MMU 920 may include a translation lookaside buffer (TLB) 922 for caching virtual-to-physical address translations, and a page miss handler 921 for accessing address translations from a page table 912 in memory 910 in response to a TLB miss (i.e., when the required address translation is not stored in the TLB 922). For example, in one embodiment, the PMH 921 implements page walk operations for accessing the page table upon a TLB miss. The PMH 921 may execute a finite state machine (FSM) to access the page table 912 and to check the permissions and attributes of the accessed page.

As illustrated, one embodiment of the TLB 922 includes a tag array 925, selection logic 926, and a data array 927 for implementing the techniques described herein for storing translations for multiple page sizes. In one embodiment, the tag array 925 has a read/content addressable memory (CAM) port for each one of the different page sizes. This way, each read port takes its set bits from different parts of the linear address (LA).

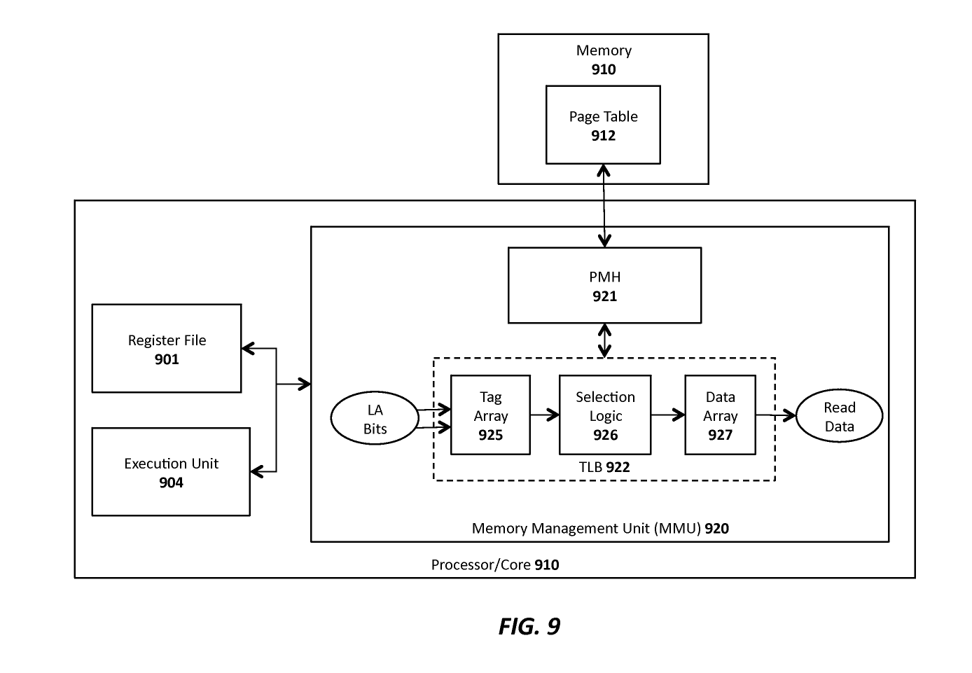

For example, referring back to FIG. 8, one read port may read set bits from LA[15:12] while the other read port may read set bits from LA[24:21]. Thus, a “small page read port” (e.g., for a 4K page) takes LA[12] as the LSB of the set bits while a “large page read port” (e.g., for a 2M page) takes LA[21] as the LSB of the set bits. In addition, each of the read ports may read different tag bits, so that the tag bits are all the LA bits higher than the set bits. For the small page read port, the tag bits are LA[::16] and for the 2M read port, the tag bits are LA[::25]. Note that the large page CAM port has a fewer number of tag bits than the small page CAM port.

In one embodiment, each entry in the tag array 925 contains a new bit called “large page” to distinguish between large and small pages. When the entry is valid, this bit indicates whether the entry is holding a large page translation (e.g., large page bit=1) or a small page translation (e.g., large page bit=0). When there is a read/compare from the array, each port qualifies its hit result with the “large page” bit. For the large read port, the hit is true only if “large page”==1. For the small read port, the hit is true only if the “large page”==0.

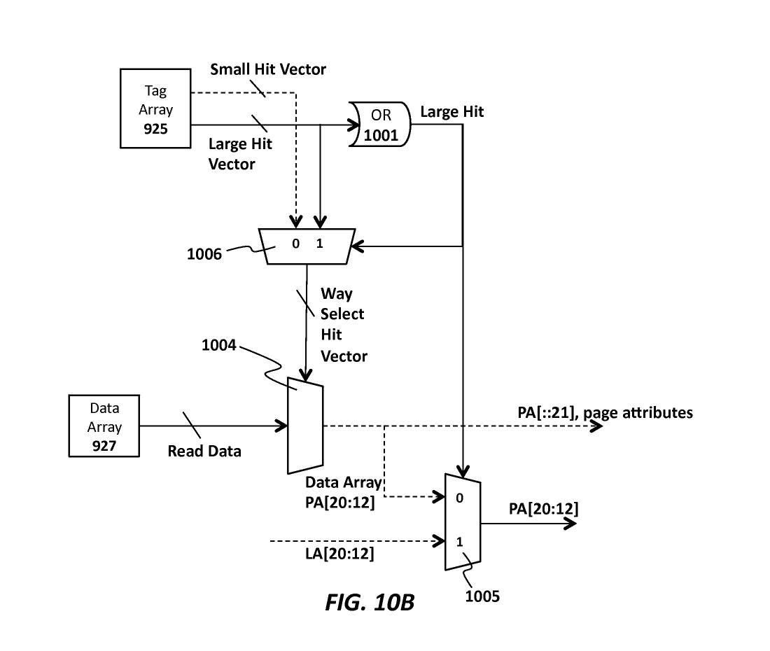

In one embodiment, the above techniques are implemented using the apparatus shown in FIG. 10A which shows the tag array 925, the data array 927 and portions of the selection logic 926 coupled between the two arrays including an OR gate 1001 and a multiplexer 1002. Specifically, the tag array 925 performs a read/compare of small set bits over the small page CAM port and performs a read/compare of the large set bits over the large page CAM port. If a “hit” occurs using the small or large set bits, the hit is qualified using the “large page” bit. If a large page hit is detected using large set bits, and the large page bit is set to 1, then a non-zero n-bit large hit vector signal is generated and applied to OR gate 1001. Any non-zero value in any of the n bits of the large hit vector signal (indicating a large page hit), results in a large hit value of 1 output from the OR gate 1001 which controls the multiplexer 1002 to select between the small set bits and the large set bits. The selected large or small set bits are applied to the data array 927 (i.e., to select one of the cache sets of the data array). Thus, a large hit value of 1 output from the OR gate 1001 causes the multiplexer 1002 to select the large set bits and a large hit value of 0 output from the OR gate 1001 causes the multiplexer 1002 to select the small set bits. In either case, the set bits are used to select a particular cache set within the TLB data array 927. In an alternate implementation, the small hit vector may be applied to an OR gate such as 1001, and the output used as a selection signal to the multiplexor 1002 (i.e., to select the small set bits for a non-zero value).

Thus, the tag array 925 only requires one write port as in a regular TLB. The write port chooses the small or large set bits according to the page size being written into the TLB. Also, the “large page” bit value is written according to the size of the page being written.

In one embodiment, the data array 927 has one read port to save power and area, and to make the data array identical to any normal TLB data array. For that, the tag hit vectors (used as way select signals, as described below) and the set bits for the data array read need to be arbitrated. In one embodiment, the arbitration policy is implemented as follows. If there is a hit in the large read port, the large set bits are used for reading the data array and the large read port hit vector is used. Otherwise, the small set bits and small read port hit vector are used.

This is illustrated generally in FIG. 10B which shows additional details of one embodiment of the selection logic 926 including multiplexers 1005-1006 and OR gate 1001. The small hit vector and large hit vector from the tag array 925 applied as inputs to multiplexer 1006 which is controlled in response to the large hit signal output from OR gate 1001. Thus, if there is a large page hit, the large hit output will be 1 and will cause the multiplexer 1006 to select the large hit vector; if there is a small page hit, the large hit output from OR gate 1001 will be 0 and will cause the multiplexer 1006 to select the small hit vector.

In one embodiment, the n-bit small/large hit vector identifies the cache way to be read from the data array 927. For example, if data array 927 is implemented as a 4-way cache, the way select hit vector may comprise a 4-bit signal, with each bit identifying a different way of data array 927 (e.g., Way1=0010, Way0=0001, etc). Thus, the large/small hit vector is applied to multiplexer 1004 to select one of the ways of the data array 927 associated with the cache set selected via the large/small set bits.

Another multiplexer 1005 is employed to select physical address (PA) bits [20:12] based on the large hit signal from OR gate 1001. If there is a large page hit, these bits are taken from the linear address bits LA[20:12] (same as bits [11:0]). If there is a small page hit these bits are taken from the data array (same as bits [::21]).

The above configuration allows the use of any entry in the TLB for any required page size. This way, the TLB is filled according to the need of the applications. There is a huge area and power saving since there is one array instead of two or more. The cost is relatively small: an extra read/CAM port in the tag array and one bit per entry to indicate the page size currently being cached. Another cost is the delay in the data array read, or alternatively, adding a read port to the data array as well. The cost of the new multiplexors is negligible.

In an alternative embodiment, the data array may be read together with the tag array by adding a read port to the data array in the same manner as described above for the tag array. This way, each page size is provided with its own read port. The arbitration between the ports is delayed and done only on the hit vectors or after the small and large way select multiplexors. In this configuration, the area and power are higher but still much lower than using separate arrays.

In addition, the array can be split so that some of the sets are unified, while some of the sets are dedicated to one page size only. For example, half of the sets may be shared for small and large pages, and the other half of the sets may be dedicated for small pages only. This way the cost of the extra read port is saved for the non-unified sets.

Alternatively or in addition, the array can be split so that some of the ways are unified, while some of the ways are dedicated to one page size only. For example, half of the ways may be shared for small and large pages, and the other half of the ways may be dedicated for small pages only. This way the cost of the extra read port is saved for the non-unified ways.

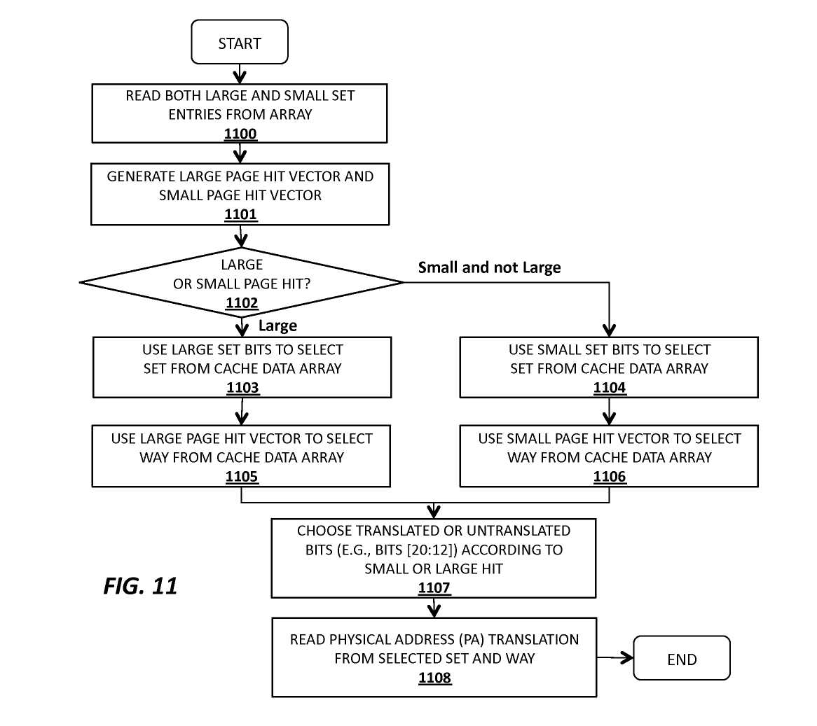

A method in accordance with one embodiment of the invention is illustrated in FIG. 11. At 1100, both the large and small set entries are read from an array (e.g., such as the TLB discussed above). At 1101, both the large page hit vector and small page hit vector are generated. At 1102, a determination is made as to whether there is a large or small page hit (e.g., based on the hit vectors from 1101). If a large page hit, then at 1103, the large set bits are used to select the set from the cache data array and at 1105 the large page hit vector is used to select the way from the data array. If a small page hit is determined at 1102, then at 1104 the small set bits are used to select the set from the cache data array and at 1106 the small page hit vector is used to select the way from the data array. In either case, at 1107, certain translated or un-translated bits may be used in the result depending on whether there is a small or large hit. For example, as described above, in one embodiment, un-translated bits LA[20:12] may be used for a large hit and translated bits PA[20:12] read from the data array 927 may be used for a small hit. At 1108, the physical address translation is read from the cache data array at the selected set and way.

While the embodiments of the invention described above control selection via a large hit vector (see FIGS. 10A-B), the same principles may be applied using the small hit vector signal. For example, the small hit vector may be applied to an OR gate to generate a small hit signal (as described above for the large hit signal) in response to a small page hit. This small hit signal may then be used to control multiplexors 1002, 1005, and 1006 as described above for the large hit signal. In addition, while embodiments of the invention are described above in the context of a specific number of cache sets and ways, the underlying principles of the invention are not limited to any particular cache configuration. Finally, while described within the context of a TLB, the underlying principles of the invention may be implemented using any type of cache.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A method comprising:
reading a first group of bits and a second group of bits from a linear address;
determining whether the linear address is associated with a large page size or a small page size;
identifying a first cache set using the first group of bits if the linear address is associated with a first page size and identifying a second cache set using the second group of bits if the linear address is associated with a second page size; and
identifying a first cache way if the linear address is associated with a first page size and identifying a second cache way if the linear address is associated with a second page size.

2. The method as in claim 1 wherein the set and way identify an entry within a translation lookaside buffer (TLB).

3. The method as in claim 2 wherein determining comprises identifying an entry in the TLB using the first or second groups of bits and reading a bit from the TLB entry indicating whether the linear address is associated with a large page or a small page.

4. The method as in claim 1 further comprising:
determining that a TLB miss has occurred when no TLB entry is identified; and
reading a physical address translation for the linear address from a page table in memory.

5. The method as in claim 4 further comprising:
storing the physical address translation in the TLB; and
setting the bit in the TLB entry to indicate whether the page associated with the linear address is a small page size or a large page size.

6. The method as in claim 5 further comprising:
locating the translation in a first cache set using the first group of bits if the page associated with the linear address is a large page size, or in a second cache set using the second group of bits if the page associated with the linear address is a small page size.

7. The method as in claim 1 wherein the first cache set and the second cache set are the same set.

8. The method as in claim 1 wherein the first cache way and the second cache way are the same way.

9. A processor comprising:
first logic to read a first group of bits and a second group of bits from a linear address;
second logic to determine whether the linear address is associated with a large page size or a small page size;
third logic to identify a first cache set using the first group of bits if the linear address is associated with a first page size and to identify a second cache set using the second group of bits if the linear address is associated with a second page size; and
fourth logic to identify a first cache way if the linear address is associated with a first page size and to identify a second cache way if the linear address is associated with a second page size.

10. The processor as in claim 9 wherein the set and way identify an entry within a translation lookaside buffer (TLB).

11. The processor as in claim 10 wherein determining comprises identifying an entry in the TLB using the first or second groups of bits and reading a bit from the TLB entry indicating whether the linear address is associated with a large page or a small page.

12. The processor as in claim 9 further comprising:
a page miss handler to read a physical address translation for the linear address from a page table in memory upon a determination that a TLB miss has occurred when no TLB entry is identified.

13. The processor as in claim 12 wherein the physical address translation is stored in the TLB and the bit in the TLB entry is set to indicate whether the page associated with the linear address is a small page size or a large page size.

14. The processor as in claim 13 wherein the translation is located in a first cache set using the first group of bits if the page associated with the linear address is a large page size, or in a second cache set using the second group of bits if the page associated with the linear address is a small page size.

15. The processor as in claim 9 wherein the first cache set and the second cache set are the same set.

16. The processor as in claim 9 wherein the first cache way and the second cache way are the same way.

17. A system comprising:
a memory for storing program code and data;
a input/output (IO) communication interface for communicating with one or more peripheral devices;
a network communication interface for communicatively coupling the system to a network; and
a processor comprising:
first logic to read a first group of bits and a second group of bits from a linear address;
second logic to determine whether the linear address is associated with a large page size or a small page size;
third logic to identify a first cache set using the first group of bits if the linear address is associated with a first page size and to identify a second cache set using the second group of bits if the linear address is associated with a second page size; and
fourth logic to identify a first cache way if the linear address is associated with a first page size and to identify a second cache way if the linear address is associated with a second page size.

18. The system as in claim 17 wherein the set and way identify an entry within a translation lookaside buffer (TLB).

19. The system as in claim 17 wherein determining comprises identifying an entry in the TLB using the first or second groups of bits and reading a bit from the TLB entry indicating whether the linear address is associated with a large page or a small page.

20. The system as in claim 17 further comprising:
a page miss handler to read a physical address translation for the linear address from a page table in memory upon a determination that a TLB miss has occurred when no TLB entry is identified.

21. The system as in claim 20 wherein the physical address translation is stored in the TLB and the bit in the TLB entry is set to indicate whether the page associated with the linear address is a small page size or a large page size.

22. The system as in claim 21 wherein the translation is located in a first cache set using the first group of bits if the page associated with the linear address is a large page size, or in a second cache set using the second group of bits if the page associated with the linear address is a small page size.

23. The system as in claim 17 wherein the first cache set and the second cache set are the same set.

24. The system as in claim 17 wherein the first cache way and the second cache way are the same way.
